(19) United States
(12) Patent Application Publication
(10) Pub. No.: US 2007/0004816 A1
(43) Pub. Date: Jan. 4, 2007

(54) Photocurable resin composition

(76) Inventors: Takao Yashiro, Tsuchiura (JP); Ryoji Tatara, Tsukuba (JP); Takayoshi Tanabe, Tsukuba (JP)

Correspondence Address: NIXON & VANDERHYE, PC, 901 NORTH GLEBE ROAD, 11TH FLOOR, ARLINGTON, VA, 22203, US

(21) Appl. No.: 10/559,534

(22) PCT Filed: Jun. 14, 2004
(86) PCT No.: PCT/NL04/00423

§ 371 Date: Jun. 13, 2006

(30) Foreign Application Priority Data
Jun. 13, 2003 (JP) JP2003-169206
Jun. 20, 2003 (JP) JP2003-175755

(51) Int. Cl. C08F 2/46

(52) U.S. Cl. 522/69

(57) ABSTRACT

The invention relates to a radiation curable composition comprising (A) a component comprising a carboxyl group that may dissociate in the presence of an acid, (B) a cationically polymerizable compound, and (C) a cationic photoinitiator.

The present invention relates to a liquid photocurable resin composition exhibiting high photocurability and producing cured products with superior mechanical strength and fracture toughness, and particularly to a photocurable resin composition useful as a resin composition for three-dimensional photofabrication of a cured product for which impact resistance is particularly required.

### PRIOR ART

In recent years, photofabrication of three-dimensional products consisting of cured resin layers integrally laminated by repeating a step of selectively irradiating a liquid photocurable material (liquid photocurable resin composition) has been proposed (for example Japanese Patent Application Laid-open No. 60-247515). A typical example of the above three-dimensional photofabrication process is as follows. A cured resin layer having a specified pattern is formed by selective exposure to radiation such as from an ultraviolet laser on the surface of the liquid photocurable resin composition in a vessel. The equivalent of one layer of a liquid photocurable resin composition is provided over this cured resin layer and the liquid surface is selectively irradiated to form a new cured resin layer integrally laminated over the cured resin layer. This step is repeated a certain number of times using the same or different irradiating patterns to obtain a three-dimensional product consisting of integrally laminated cured resin layers. This three-dimensional photofabrication method has attracted considerable attention because a three-dimensional product having a complicated shape can be easily formed in a short period of time.

Many three-dimensional products formed by such a three-dimensional fabrication method are used for design models, prototypes of mechanical parts, and the like. When these three-dimensional products are used particularly for prototypes of mechanical parts, such objects must be formed by high-precision microfabrication strictly conforming to a design drawing, and must exhibit sufficient mechanical strength and superior heat resistance under use conditions. In particular, in addition to a shape confirmation test, in the function evaluation test such as a drop test applied to in the same manner as in general-purpose resins such as ABS resins, superior outstanding impact resistance, outstanding fracture toughness, and the like are required.

Conventional resin compositions known today cannot produce a cured product which satisfies the required properties like for example high impact strength.

### PROBLEMS TO BE SOLVED BY THE INVENTION

An object of the present invention is to provide a liquid photocurable resin composition which can produce cured products having superior impact resistance.

### MEANS FOR SOLVING THE PROBLEMS

The present inventors have conducted extensive studies and have discovered that a composition which contains a component comprising a carboxyl group that may dissociate to carbondioxide in the presence of an acid can produce a cured product having superior folding resistance, film impact, and impact resistance.

Specifically, the present invention provides a liquid photocurable resin composition comprising:

(A) a component comprising a carboxyl group that may dissociate in the presence of an acid,

(B) a cationically polymerizable compound, and

(C) a cationic photoinitiator.

The present invention further provides a photofabricated product obtained by curing the above liquid photocurable resin composition by applying light.

### PREFERRED EMBODIMENT OF THE INVENTION

There are no specific limitations to the component (A) used in the liquid photocurable resin composition inasmuch as the component comprises a carboxyl group that may dissociate in the presence of an acid. This acid is usually supplied as an acid produced by decomposition of the cationic photoinitiator (C) by irradiation. The component (A) is preferable a compound having a structure shown by the following formula (1). 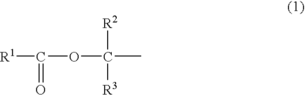
wherein R¹ represents an organic group having a polymerizable carbon-carbon double bond and R² and R³ individually represent an alkyl group having 1-10 carbon atoms or an aryl group having 6-14 carbon atoms.

Given as examples of the alkyl group having 1-10 carbon atoms represented by R² or R³ in the above formula (1) are a methyl group, ethyl group, n-propyl group, i-propyl group, n-butyl group, i-butyl group, sec-butyl group, t-butyl group, pentyl group, neopentyl group, hexyl group, heptyl group, octyl group, 2-ethylhexyl group, nonyl group, and decyl group.

Given as examples of the aryl group having 6-14 carbon atoms are a phenyl group, tolyl group, tolyl group, tolyl group, 4-chlorophenyl group, 4-t-butylphenyl group, 1-naphthyl group, and benzyl group.

Specific examples include the following compound (a), compound (b), and (co)polymer (c). These compound (a), compound (b), and (co)polymer (c) can be used as component (A) either individually or in combination of two or more.

The compound (a) is a compound having a structure of the above formula (1) and having at least one polymerizable carbon-carbon double bond in the molecule.

The compound (a) can be synthesized by, for example, an esterification reaction of a polyhydric alcohol having at least one tertiary hydroxyl group and a monovalent carboxylic acid having at least one polymerizable carbon-carbon double bond. The esterification reaction is carried out by the following methods, for example.

(1) An acid chloride method of reacting the polyhydric alcohol with an acid chloride of the carboxylic acid compound.

(2) A method of reacting the polyhydric alcohol with the carboxylic acid compound using a condensing agent such as dicyclohexylcarbodiimide.

(3) A method of reacting the polyhydric alcohol with the carboxylic acid compound using a strong acid anhydride such as trifluoroacetic acid anhydride as a dehydrating agent.

(4) A trans esterification method of esters of the polyhydric alcohol and the carboxylic acid compound.

As examples of the polyhydric alcohol having a tertiary hydroxyl group used for synthesizing the compound (a), compounds of following formulas (4) to (6) can be given. 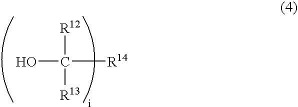
wherein R¹² and R¹³ individually represent an alkyl group having 1-10 carbon atoms or an aryl group having 6-14 carbon atoms, R¹⁴ is an organic group with a valence of i, the R¹⁴ group indicating a single bond when i is 2, and i is an integer of 2-4, provided that one of R¹², R¹³, and R¹⁴ is an alkyl group having 1-10 carbon atoms. 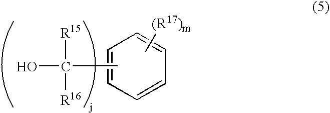
wherein R¹⁵ represents an alkyl group having 1-10 carbon atoms, R¹⁸ represents an alkyl group having 1-10 carbon atoms or an aryl group having 6-14 carbon atoms, R¹⁷ individually represents an alkyl group having 1-5 carbon atoms, j is an integer of 2-4, and m is an integer of 0-4, provided j+m≦6 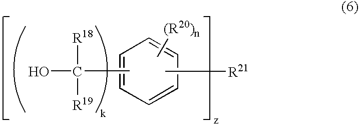
wherein R¹⁸ represents an alkyl group having 1-10 carbon atoms, R¹⁹ represents an alkyl group having 1-10 carbon atoms or an aryl group having 6-14 carbon atoms, R²⁰ individually represents an alkyl group having 1-5 carbon atoms, R²¹ is an organic group having a valence of z, —O—, —S—, —CO—, or SO₂, k is an integer of 1 or 2, n is an integer of 0-3, and z is an integer of 2-4.

As examples of the compound of the formula (4), divalent tertiary alcohols such as 2,3-dimethyl-2,3-butanediol, 2,3-diethyl-2,3-butanediol, 2,3-di-n-propyl-2,3-butanediol, 2,3-diphenyl-2,3-butanediol, 2,4-dimethyl-2,4-pentanediol, 2,4-diethyl-2,4-pentanediol, 2,4-di-n-propyl-2,4-pentanediol, 2,4-diphenyl-2,4-pentanediol, 2,5-dimethyl-2,5-hexanediol, 2,5-diethyl-2,5-hexanediol, 2,5-di-n-propyl-2,5-hexanediol, 2,5-diphenyl-2,5-hexanediol, 2,6-dimethyl-2,6-heptanediol, 2,6-diethyl-2,6-heptanediol, 2,6-di-n-propyl-2,6-heptanediol, and 2,6-diphenyl-2,6-heptanediol; trivalent tertiary alcohols such as 2,4-dimethyl-2,4-dihydroxy-3-(2-hydroxypropyl)pentane, 2,4-diethyl-2,4-dihydroxy-3-(2-hydroxypropyl)pentane, 2,5-dimethyl-2,5-dihydroxy-3-(2-hydroxypropyl)hexane, and 2,5-diethyl-2,5-dihydroxy-3-(2-hydroxypropyl)hexane; and tetravalent tertiary alcohols such as 2,4-dimethyl-2,4-dihydroxy-3,3-di(2-hydroxypropyl)pentane, 2,4-diethyl-2,4-dihydroxy-3,3-di(2-hydroxypropyl)pentane, 2,5-dimethyl-2,5-dihydroxy-3,4-di(2-hydroxypropyl)hexane, and 2,5-diethyl-2,4-dihydroxy-3,4-di(2-hydroxypropyl)hexane can be given.

As examples of the compound of the formula (5), 1,4-di(2-hydroxypropyl)benzene, 1,3-di(2-hydroxypropyl)benzene, 1,3,5-tri(2-hydroxypropyl)benzene, and 1,2,4,5-tetra(2-hydroxypropyl)benzene can be given.

As examples of the compound of the formula (6), 2,2-bis{4-(2-hydroxypropyl)phenyl}propane, 1,2,2-tris{4-(2-hydroxypropyl)phenyl}propane, 1,2,3,4-tetra{4-(2-hydroxypropyl)phenyl}butane, bis{4-(2-hydroxypropyl)phenyl}ether, bis{4-(2-hydroxypropyl)phenyl}sulfide, bis{4-(2-hydroxypropyl)phenyl}ketone, and bis{4-(2-hydroxypropyl)phenyl}sulfone can be given.

Of these 2-4 valent tertiary alcohols of the formulas (4) to (6), 2,5-dimethyl-2,5-hexanediol, 1,4-di(2-hydroxypropyl)benzene, 1,3-di(2-hydroxypropyl)benzene, and the like are preferable, with a particularly preferable tertiary alcohol being 2,5-dimethyl-2,5-hexanediol.

As examples of the monovalent carboxylic acid having a polymerizable carbon-carbon double bond monomer used for synthesizing the compound (a), (meth)acrylic acid, crotonic acid, cinnamic acid, maleic acid, fumaric acid, itaconic acid, 2-(meth)acryloxyethylcarboxylic acid, and 4-(meth)acryloxy cyclohexylcarboxylic acid can be given.

As the monovalent carboxylic acid having one polymerizable carbon-carbon double bond mentioned above, a (meth)acrylic acid is particularly preferable in view of the curing reaction rate of the compound (a).

As specific examples of the compound (a), 2,5-dimethylhexane-2,5-di(meth)acrylate and 1,3-di(2-hydroxypropyl)benzene-di(meth)acrylate can be given.

The compound (b) is a compound having one polymerizable carbon-carbon double bond and having the following structural formula (2) or (3). 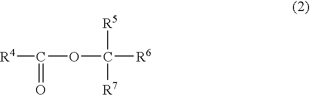
wherein, R⁴ represents an organic group having a polymerizable carbon-carbon double bond, R⁵ represents an alkyl group having 1-10 carbon atoms, and R⁶ and R⁷ represent an alkyl group having 1-10 carbon atoms, monovalent alicyclic group having 6-20 carbon atoms, or monovalent aryl group having 6-20 carbon atoms. 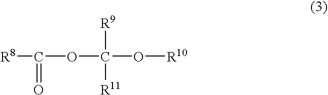
wherein R⁸ represents an organic group having a polymerizable carbon-carbon double bond, R⁹ represents a hydrogen atom, alkyl group having 1-10 carbon atoms, alicyclic group having 3-10 carbon atoms, aryl group having 6-10 carbon atoms, or aralkyl group having 7-11 carbon atoms, R¹⁰ and R¹¹ individually represent an alkyl group having 1-10 carbon atoms, haloalkyl group having 1-10 carbon atoms, alicyclic group having 3-10 carbon atoms, aryl group having 6-10 carbon atoms, or aralkyl group having 7-11 carbon atoms, or any two of R⁹, R¹⁰, and R¹¹ may bond to form a 5-7 member ring.

Given as examples of the alkyl group having 1-10 carbon atoms represented by R⁵, R⁶, or R⁷ in the above structural formula (2) are a methyl group, ethyl group, n-propyl group, i-propyl group, n-butyl group, i-butyl group, t-butyl group, sec-butyl group, pentyl group, neopentyl group, hexyl group, heptyl group, octyl group, 2-ethylhexyl group, nonyl group, and decyl group.

As examples of the monovalent alicyclic group having 6-20 carbon atoms represented by R⁶ or R⁷ in the structural formula (2), cyclohexyl group, cycloheptyl group, cyclooctyl group, 2-methylcyclohexyl group, 3-methylcyclohexyl group, 4-methylcyclohexyl group, 4-chlorocyclohexyl group, 4-t-butylcyclohexyl group, norbornyl group, isobornyl group, adamantyl group, 2-methyladamantyl group, and tricyclodecanyl group can be given.

Given as examples of the monovalent aryl group having 6-20 carbon atoms represented by R⁶ or R⁷ in the structural formula (2) are a phenyl group, o-tolyl group, m-tolyl group, p-tolyl group, 4-chlorophenyl group, 4-t-butylphenyl group, 1-naphthyl group, and benzyl group.

R⁹ in the structural formula (3) is a hydrogen atom, alkyl group having 1-10 carbon atoms, alicyclic group having 3-10 carbon atoms, aryl group having 6-10 carbon atoms, or aralkyl group having 7-11 carbon atoms.

As examples of the alkyl group having 1-10 carbon atoms for R⁹ in the structural formula (3), a methyl group, ethyl group, n-propyl group, i-propyl group, n-butyl group, i-butyl group, sec-butyl group, t-butyl group, n-pentyl group, neopentyl group, n-hexyl group, n-heptyl group, n-octyl group, 2-ethylhexyl group, n-nonyl group, and n-decyl group can be given.

Given as examples of the monovalent cyclic organic group having 3-10 carbon atoms for R⁹ in the structural formula (3) are a cyclopentyl group, cyclobutyl group, cyclopentyl group, cyclohexyl group, cycloheptyl group, cyclooctyl group, norbornyl group, and isobornyl group can be given.

Given as examples of the monovalent aryl group having 6-10 carbon atoms represented by R⁹ in the structural formula (3) are a phenyl group, o-tolyl group, m-tolyl group, p-tolyl group, xylyl group, cumenyl group, and 1-naphthyl group.

As examples of the aralkyl group having 7-11 carbon atoms, a benzyl group, α-methylbenzyl group, phenethyl group, and naphthylmethyl group can be given.

R¹⁰ and R¹¹ in the structural formula (3) are individually an alkyl group having 1-10 carbon atoms, haloalkyl group having 1-10 carbon atoms, alicyclic group having 3-10 carbon atoms, aryl group having 7-11 carbon atoms, or aralkyl group having 6-10 carbon atoms. As specific examples of these groups excepting for the haloalkyl group, the same groups as mentioned above for the R⁹ can be given. As examples of the haloalkyl group, a trifluoroethyl group, hexafluoropropyl group, and heptadecafluorodecyl group can be given.

Any two of R⁹, R¹⁰, and R¹¹ may bond to form a 5-7 member ring. Given as examples of the 5-7 member ring formed from R⁹ and R¹¹ are a cyclopentyl group, cyclohexyl group, and cycloheptyl group. Given as examples of the 5-7 member ring formed from R⁹ and R¹⁰ or from R¹⁰ and R¹¹ are a tetrahydrofuranyl group and tetrahydropyranyl group.

As specific examples of the monovalent carboxylic acid having one polymerizable carbon-carbon double bond of the compound (b) having the structural formula (2) or (3), the same groups as mentioned above in connection with the structural formula (1) can be give.

As specific examples of the above-mentioned compound (b), t-butyl (meth)acrylate, tetrahydropyranyl(meth)acrylate, 2-t-butoxycarbonylmethyl(meth)acrylate, 2-benzyloxycarbonylethyl(meth)acrylate, 2-methyladamantyl(meth)acrylate, 1,1-dimethyl-3-oxobutyl(meth)acrylate, and 2-benzylpropyl(meth)acrylate can be given.

The (co)polymer (c) in the present invention is a (co)polymer comprising the compounds (a) and/or (b) as monomer constituents. The (co)polymer (c) may include, in addition to the compounds (a) and/or (b), any (co)polymerizable monomers other than the compounds (a) or (b) as the monomer constituents.

There are no specific limitations to the amount of the component (b) contained in the (co)polymer (c) of the present invention in so far as the effects of the present invention are not adversely affected. The amount is usually 10-100 mol %, preferably 20-100 mol %, and more preferably 30-100 mol %. The component (b) may be used in the (co)polymer (c) either individually or in combination of two or more. If the amount of the component (b) is less than 10 mol %, the impact resistance of the resulting photofabricated product may not be sufficient.

The component (a) used for the (co)polymer (c) introduces a moderate branch structure into the (co)polymer (c) and provides an effect of improving initial mechanical and thermal characteristics of the cured resin by decreasing mobility of the polymer molecule chains and, at the same time, decreases the molecular weight of the (co)polymer (c) by the action of an acid. The amount is usually 0-40 mol %, preferably 0-30 mol %, and more preferably 0-25 mol %. The component (a) may be used in the (co)polymer (c) either individually or in combination of two or more. If the amount of the component (a) is more than 40 mol %, the solubility of the (co)polymer in the resin decreases and it may be difficult to obtain a homogeneous liquid resin.

Given as examples of the optional copolymerizable monomers are aromatic vinyl compounds such as styrene, α-methylstyrene, p-methylstyrene, p-chlorostyrene, and p-methoxystyrene; hetero atom-containing alicyclic vinyl compounds such as N-vinylpyrrolidone and N-vinylcaprolactam; cyano group-containing vinyl compounds such as (meth)acrylonitrile and cyanated vinylidene; (meth)acrylamides or derivatives thereof such as (meth)acrylamide, N,N-dimethyl(meth)acrylamide, and N,N-dimethylol (meth)acrylamide; non-polar (meth)acrylates such as methyl(meth)acrylate, ethyl(meth)acrylate, n-propyl(meth)acrylate, i-propyl(meth)acrylate, 2-hydroxyethyl (meth)acrylate, phenyl(meth)acrylate, cyclohexyl(meth)acrylate, benzyl(meth)acrylate, isobornyl(meth)acrylate, and tricyclodecanyl(meth)acrylate; carboxyl-group containing (meth)acrylates such as acrylic acid, crotonic acid, cinnamic acid, maleic acid, fumaric acid, itaconic acid, 2-(meth)acryloxyethylcarboxylic acid, and 4-(meth)acryloxycyclohexylcarboxylic acid; and phenolic hydroxyl group-containing aromatic vinyl compounds such as o-hydroxystyrene, m-hydroxystyrene, p-hydroxystyrene, o-iso-propenylphenol, m-iso-propenylphenol, and p-iso-propenyl phenol. These monomers can be used either individually or in combination of two or more.

The polymerization for producing the (co)polymer (c) can be carried out by known methods, for example by using a polymerization initiator, molecular weight modifier, and the like. As examples of the polymerization initiator benzoyl peroxide, lauroyl peroxide, 2,2′-azobisisobutylonitrile, 4,4′-azobis(4-cyanovaleric acid), and 2,2′-azobis-(4-methoxy-2,4-dimethylvaleronitrile) can be given. These polymerization initiators can be used either individually or in combination of two or more.

As examples of the molecular weight modifiers halogenated hydrocarbons such as carbon tetrachloride, chloroform, carbon tetrabromide; mercaptans such as n-hexylmercaptan, n-octylmercaptan, n-dodecylmercaptan, t-dodecylmercaptan, thioglycolic acid, and thiopropionic acid; xanthogens such as dimethylxanthogen disulfite and diisopropylxanthogen disulfite; terpinolene, and α-methylstyrene dimer can be given. These molecular weight modifiers can be used either individually or in combination of two or more.

The polystyrene-reduced weight average molecular weight (hereinafter referred to as “Mw”) of the copolymer (c) determined by gel permeation chromatography (GPC) is usually 1,000-500,000, preferably 5,000-200,000, and still more preferably 10,000-150,000. If the Mw of the copolymer (c) is less than 1,000, the mechanical and thermal characteristics of the photofabricated products tend to decrease. If the Mw exceeds 500,000, solubility in a liquid resin decreases making it difficult to obtain a homogeneous liquid resin. In the present invention, the (co)polymer (c) can be used either individually or in combinations of two or more.

As specific examples of the (co)polymer (c), a copolymer of p-isopropenyl phenol and t-butyl acrylate and a copolymer of styrene and 2-benzylpropyl(meth)acrylate can be given.

The proportion of the component (A) used in the liquid photocurable resin composition of the present invention is usually 1-50 wt %, preferably 5-30 wt %, and more preferably 5-20 wt %. The presence of component (A) in the above amounts gives products having sufficient impact resistance and tenacity, and also high mechanical strength, minimal cure shrinkage, a high dimensional accuracy, and no deformation over time. The components (a), (b), and (c) can be used either individually or in combinations of two or more.

As examples of the cationically polymerizable compound used in the present invention as the component (B), an epoxy compound, oxetane compound, oxorane compound, cyclic acetal compound, cyclic lactone compound, thiirane compound, thiethane compound, spiro orthoester compound which is a reaction product of an epoxy compound and lactone, vinyl ether compound, and ethylenically unsaturated compound can be given.

Suitable epoxy compounds which can be used as the component (B) are generally known in the art. Specific examples of suitable epoxy compounds include 3,4-epoxycyclohexylmethyl-3′,4′-epoxycyclohexanecarboxylate, bis(3,4-epoxycyclohexylmethyl)adipate, ε-caprolactone-modified 3,4-epoxycyclohexylmethyl-3′,4′epoxycyclohexanecarboxylate, trimethylcaprolactone-modified 3,4-epoxycyclohexylmethyl-3′,4′-epoxycyclohexanecarboxylate, and β-methyl-δ-valerolactone-modified 3,4-epoxycyclohexylmethyl-3′,4′-epoxycyclohexanecarboxylate, bisphenol A diglycidyl ether, bisphenol F diglycidyl ether, hydrogenated bisphenol A diglycidyl ether, hydrogenated bisphenol F diglycidyl ether, 1,4-butanediol diglycidyl ether, 1,6-hexanediol diglycidyl ether, trimethylolpropane triglycidyl ether, glycerol triglycidyl ether, polyethylene glycol diglycidyl ether and polypropylene glycol diglycidyl ether.

As other cationically polymerizable organic compounds used as the component (A), oxetanes such as trimethylene oxide, 3,3-dimethyl oxetane, 3,3-dichloromethyl oxetane, 3-ethyl-3-phenoxymethyl oxetane, and bis(3-ethyl-3-methyloxy)butane; oxolanes such as tetrahydrofuran and 2,3-dimethyltetrahydrofuran; cyclic acetals such as trioxane, 1,3-dioxolane, and 1,3,6-trioxanecyclooctane; cyclic lactones such as γ-propyolactone and ε-caprolactone; thiiranes such as ethylene sulfide, 1,2-propylene sulfide, and thioepichlorohydrin; thiethanes such as 3,3-dimethylthietane; vinyl ethers such as ethylene glycol divinyl ether, triethylene glycol divinyl ether, and trimethylolpropane trivinyl ether; ethylenically unsaturated compounds such as vinyl cyclohexane, isobutylene, and polybutadiene; derivatives of these compounds; and the like can be given.

It is preferred that the component (B) contains 50 wt % or more of epoxy compounds to ensure a high cure speed and excellent mechanical strength.

The cationically polymerizable compounds may be used either individually or in combination of two or more as the component (B).

The component (B) is incorporated in the composition of the present invention in an amount from 20-90 wt %, preferably from 30-85 wt %, and more preferably from 30-75 wt %. The presence of component (B) in the above amounts has the advantage of generating photofabricated products that have minimal warping and excellent mechanical and thermal characteristics.

The component (C) used in the present invention is a cationic photoinitiator. The component (C) can decompose the ester groups of the above-mentioned compound (a), compound (b), and (co)polymer (c) upon exposure to energy rays such as light and generate a substance which initiates the cationic polymerization of the components (B).

The energy rays here refers to visible light, ultraviolet light, infrared light, X-rays, α-rays, β-rays, γ-rays, and the like. As examples of preferable compounds used as the component (C), onium salts having a structure of the following formula (7) can be given.
[R²²ₐR²³_{b}R¹⁰_{c}R²⁴_{d}W]+p[MXₒ₊ₚ]^{-p} (7)
wherein the cation is an onium ion; W is S, Se, Te, P, As, Sb, Bi, O, I, Br, Cl, or —N═N; R²², R²³, R²⁴, and R²⁵ are the same or different organic groups; a, b, c, and d are individually integers of 0-3, provided that (a+b+c+d) is equal to the valence of W; M is a metal or a metalloid which constitutes a center atom of the halide complex [MXₒ₊ₚ], such as B, P, As, Sb, Fe, Sn, Bi, Al, Ca, In, Ti, Zn, Sc, V, Cr, Mn, and Co; X is a halogen atom such as F, Cl, and Br; p is a positive charge of a halide complex ion; and o is a valence of M.

The onium salt generates a Lewis acid upon exposure to light.

As specific examples of an anion [MXₒ₊ₚ] in the formula (7), tetrafluoroborate (BF₄⁻), hexafluorophosphate (PF₆⁻), hexafluoroantimonate (SbF₆⁻), hexafluoroarsenate (AsF₆⁻), and hexachloroantimonate (SbCl₆⁻) can be given.

Onium salts having an anion represented by [MXₒ(OH)⁻] can be used. Moreover, onium salts having other anions such as a perchloric acid ion (ClO₄⁻), trifluoromethanesulfonic acid ion (CF₃SO₃⁻), fluorosulfonic acid ion (FSO₃⁻), toluenesulfonic acid ion, trinitrobenzenesulfonic acid anion, and trinitrotoluenesulfonic acid anion can be also used.

The cationically polymerizable compounds may be used either individually or in combination of two or more as the component (C).

The proportion of the component (C) used in the liquid photocurable resin composition of the present invention is usually 0.1-10 wt %, preferably 0.2-5 wt %, and more preferably 0.3-3 wt %. It is desirable to add elastomer particles (D) having an average particle diameter of 10-1,000 nm to the liquid photocurable resin composition of the present invention with an objective of improving the impact resistance.

Given as examples of the component (D) are elastomer particles containing a basic component such as polybutadiene, polyisoprene, butadiene/acrylonitrile copolymer, styrene/butadiene copolymer, styrene/isoprene copolymer, ethylene/propylene copolymer, ethylene/α-olefin copolymer, ethylene/α-olefin/polyene copolymer, acrylic rubber, butadiene/(meth)acrylate copolymer, styrene/butadiene block copolymer, and styrene/isoprene block copolymer.

Moreover, core-shell type particles produced by coating these elastomer particles with a methyl methacrylate polymer, methyl methacrylate/glycidyl methacrylate copolymer, and the like can also be given. The ratio of the core radius to the shell thickness is usually from 1/2 to 1000/1, preferably from 1/1 to 200/1 (for example, if the core radius is 350 nm and the shell thickness is 10 nm, the ratio is expressed as 35/1).

In the case of core/shell type particles, among the above-mentioned elastomer particles, elastomer particles in which a partially crosslinked core of polybutadiene, polyisoprene, styrene/butadiene copolymer, styrene/isoprene copolymer, butadiene/(meth)acrylate copolymer, styrene/butadiene block copolymer, and styrene/isoprene block copolymer is coated with methyl methacrylate polymer, methyl methacrylate/glycidyl methacrylate copolymer are particularly preferable.

In addition, elastomer particles may contain a crosslinking structure therein. The crosslinking structure may be introduced by a conventional method. As examples of crosslinking agents used in such a method, divinylbenzene, ethylene glycol di(meth)acrylate, diallylmaleate, triallylcyanurate, triallylisocyanurate, diallylphthalate, trimethylolpropane triacrylate, allyl methacrylate, and the like can be given.

Examples of commercially available products of these core-shell type elastomer particles are Reginous Bond RKB (manufactured by Reginous Chemical Industries Co., Ltd.), Techno MBS-61, MBS-69 (manufactured by Techno Polymer Co., Ltd.), and the like can be given.

These elastomer particles can be used either individually or in combinations of two or more as the component (D).

The proportion of the component (D) used in the liquid photocurable resin composition of the present invention is usually 1-35 wt %, more preferably 3-30 wt %, and even more preferably 5-20 wt %. The presence of component (D) has the advantage of the ability to provide photofabricated parts that show increased impact resistance and fracture toughness.

An ethylenically unsaturated monomer other than the compounds of the component (A) may further be incorporated in the liquid photocurable resin composition of the present invention as a component (E). The component (E) is a compound having an ethylenically unsaturated bond (C═C) in the molecule and includes monofunctional monomers having one ethylenically unsaturated bond in the molecule and polyfunctional monomers having two or more ethylenically unsaturated bonds in the molecule.

Examples of the monofunctional monomers suitably used as the component (E) include for example isobornyl(meth)acrylate, lauryl(meth)acrylate, and phenoxyethyl(meth)acrylate.

Examples of the polyfunctional monomers suitably used as the component (E) include trimethylolpropane tri(meth)acrylate, EO-modified trimethylolpropane tri(meth)acrylate, dipentaerythritol hexa(meth)acrylate, dipentaerythritol penta(meth)acrylate, and ditrimethylolpropane tetra(meth)acrylate. Presence of one or more of these compounds assist in maintaining the forming characteristics and initial mechanical characteristics of the parts.

The amount of the component (E) used in the liquid photocurable resin composition of the present invention is usually 1-50 wt %, more preferably 1-25 wt %, and even more preferably 1-10 wt %.

Each of the above monofunctional and polyfunctional monomers can be used either individually or in combination of two or more, or in combinations of at least one monofunctional monomer and at least one polyfunctional monomer as the component (E).

When the component (E) is added, it is desirable that the photocurable resin composition of the present invention further comprises a radical photoinitiator (E) as component (F). Upon exposure to energy rays such as light, the component (F) is decomposed and evolves radicals to initiate the radical polymerization of the compounds (a) and (b) of the component (A) and the component (E).

Examples of the radical photoinitiator that can be used as the component (F) include benzyl dimethyl ketal, 1-hydroxycyclohexylphenyl ketone, 2,4,6-trimethylbenzoyldiphenylphosphine oxide and for example 2-benzyl-2-dimethylamino-1-(4-morpholinophenyl)-butan-1-one. The radical photoinitiators can be used either individually or in combinations of two or more as the component (F).

The proportion of the component (F) used in the liquid photocurable resin composition of the present invention is usually 0.01-10 wt %, and preferably 0.1-8 wt %.

The liquid photocurable resin composition of the present invention may further comprise a polyether polyol compound having one or more hydroxyl groups in the molecule as a component (G). A polyether polyol (G) may be added to increase photocurability of the resin composition, and to improve form stability (suppressing deformation with time) and physical stability (suppressing change in mechanical characteristics with time) of the three-dimensional products obtained by photofabrication. As examples of the component (G), polyether polyols obtained by modifying a polyhydric alcohol containing three or more hydroxyl groups, such as trimethylolpropane, glycerol, pentaerythritol, sorbitol, sucrose, or quadrol, with a cyclic ether compound, such as ethylene oxide (EO), propylene oxide (PO), butylene oxide, or tetrahydrofuran can be given. Specific examples of the component (G) include EO-modified trimethylolpropane, PO-modified trimethylolpropane, tetrahydrofuran-modified trimethylolpropane, EO-modified glycerol, PO-modified glycerol, tetrahydrofuran-modified glycerol, EO-modified pentaerythritol, PO-modified pentaerythritol, tetrahydrofuran-modified pentaerythritol, EO-modified sorbitol, PO-modified sorbitol, EO-modified sucrose, PO-modified sucrose, and EO-modified quadrol. Of these, EO-modified trimethylolpropane, PO-modified trimethylolpropane, PO-modified glycerol, and PO-modified sorbitol are preferable.

The molecular weight of the polyether polyol used as the component (G) is preferably 100-2,000, and more preferably 160-1,000.

The proportion of the component (G) used in the liquid photocurable resin composition of the present invention is usually 0-35 wt %, preferably 5-30 wt %, and particularly preferably 5-25 wt %.

The liquid photocurable resin composition of the present invention may further comprise a photosensitizer (polymerization promotor), reactive diluent, and the like. As examples of the photosensitizer, amine compounds such as triethanolamine, methyldiethanolamine, triethylamine, and diethylamine, thioxanethone, derivatives of thioxanethone, anthraquinone, derivatives of anthraquinone, anthracene, derivatives of anthracene, perylene, derivatives of perylene, benzophenone, benzoin isopropyl ether, and the like can be given. As examples of reactive diluents, vinyl ethers, vinyl sulfides, vinylurethanes, urethane acrylates, and vinylureas can be given.

Moreover, various additives may be added to the liquid photocurable resin composition for photofabrication of the present invention as other optional components insofar as the objects and effects of the present invention are not impaired. Examples of such additives include polymers or oligomers such as epoxy resin, polyamide, polyamideimide, polyurethane, polybutadiene, polychloroprene, polyether, polyester, styrene-butadiene block copolymer, petroleum resin, xylene resin, ketone resin, cellulose resin, fluorine-containing oligomer, silicone-containing oligomer, and polysulfide oligomer, polymerization inhibitors such as phenothiazine and 2,6-di-t-butyl-4-methylphenol, polymerization initiation adjuvant, leveling agents, wettability improvers, surfactants, plasticizers, UV absorbers, silane coupling agents, inorganic fillers, pigments, dyes, and the like.

The liquid photocurable resin composition of the present invention can be produced by homogeneously mixing the components (A)-(G) and, if required, the above optional components. Viscosity (at 25° C.) of the liquid photocurable resin composition prepared in this manner is preferably 10-20,000 cps, more preferably 50-10,000 cps, and particularly 50-5,000 cps.

The liquid photocurable resin composition of the present invention thus produced has good photocurability and excels in mechanical strength, particularly in impact resistance, of the cured products, and is suitably used as a liquid photocurable resin composition for the photofabrication of three-dimensional products. In the photofabrication, the liquid photocurable resin composition of the present invention is provided with energy required for curing by being selectively irradiated with light such as visible light, ultraviolet light, and infrared light to form a three-dimensional product with a desired shape.

As the means of selectively irradiating the liquid photocurable resin composition, various means can be employed without specific limitations. For example, a means of irradiating the composition while scanning with laser beams or focused rays converged by lenses, mirrors, and the like, a means of irradiating the composition with unfocused rays via a mask having a phototransmission area with a specified pattern, a means of irradiating the composition via optical fibers corresponding to a specified pattern of a photoconductive material comprising bundled multiple optical fibers, and the like can be employed. When using a mask, a mask which electrooptically forms a mask image consisting of a phototransmission area and a non-phototransmission area in accordance with a specified pattern by the same principle as that of a liquid crystal display can be used. If minute parts or high dimensional accuracy are required in the target three-dimensional product, a means of scanning with laser beams with a small spot diameter is preferably employed as a device for selectively irradiating the composition with light. The surface of the resin composition in a vessel to be irradiated (for example, scanning plane of focused rays) may be a liquid surface of the resin composition or an interface between the resin composition and the transparent wall of the vessel. When the liquid surface of the resin composition or the interface between the resin composition and the wall of the vessel is irradiated, the composition can be exposed to light either directly or indirectly via the wall of the vessel.

In the photofabrication of three-dimensional products, after curing a predetermined area of the resin composition, the cured area is laminated by continuously or gradually moving the irradiation spot (irradiation surface) from the cured area to the uncured area to form a desired three-dimensional product. The irradiation spot can be moved by, for example, moving any one of a light source, vessel of the resin composition, or the cured area of the resin composition, or providing additional resin composition to the vessel. A typical example of the photofabrication is as follows. A supporting stage capable of vertically moving is installed in a vessel containing a resin composition. The resin composition is supplied onto the supporting stage by minutely lowering (submerging) the stage from the surface of liquid resin composition, thereby forming a thin layer (1) of the resin composition. This thin layer (1) is selectively irradiated with light to form a solid cured resin layer (1). The liquid photocurable resin composition is supplied onto this cured resin layer (1) to form a thin layer (2). This thin layer (2) is selectively irradiated with light to form a cured resin layer (2) integrally laminated on the cured resin layer (1). This step is repeated for a certain number of times while using either the same or different irradiation patterns to form a three-dimensional product consisting of integrally laminated cured resin layers (n).

The resulting three-dimensional product is then removed from the vessel. After the residual unreacted resin composition remaining on the surface is removed, the three-dimensional product is optionally washed. As washing agents, alcohol-type organic solvents such as isopropyl alcohol and ethyl alcohol, ketone-type organic solvents such as acetone, ethyl acetate, and methyl ethyl ketone, aliphatic organic solvents such as terpenes, and low-viscosity heat curable or photo curable resins can be given. When fabricating a three-dimensional product having surface smoothness, it is preferable to wash the surface of the three-dimensional product using a heat curable or photo curable resin. In this case, postcure by irradiating with heat or light is required in accordance with the types of curable resins used for washing. Since not only the resins on the surface of the object but also the uncured resin composition remaining inside the three-dimensional products can be cured by the postcure, it is also preferable to perform the postcure after washing with organic solvents.

The three-dimensional products thus obtained has a high dimensional accuracy and exhibit excellent thermal characteristics, particularly excellent impact resistance. Furthermore, after the washing the surface of the three-dimensional product may be coated with a heat curable or photo curable hard coating material in order to improve the surface hardness and heat resistance of the three-dimensional products. As these hard coating materials, organic coating materials such as acrylic resin, epoxy resin, and silicone resin or inorganic hard coating materials can be used.

To further increase the impact resistance of the photofabricated products of the present invention, it is desirable to treat the photofabricated products with heat usually at a temperature range from 40-200° C., preferably from 80-120° C., and more preferably from 80-120° C. The heat treatment causes the component (A) to sufficiently decompose, resulting in excellent impact resistance of the product. If the temperature of the heat treatment is less than 40° C., decomposition of the component (A) proceeds only insufficiently, which may give rise to lowered impact resistance. If the temperature is more than 200° C., the photofabricated product may be distorted with heat, resulting in an impairing dimensional accuracy.

### EXAMPLES

The present invention will be described in more detail by way of Examples which should not be construed as limiting the present invention.

### Examples and Comparative Examples

A reaction vessel equipped with a stirrer was charged with components shown in Table 1 and the mixture was stirred at 60° C. for three hours to prepare a liquid composition. The amount of the components is indicated by part by weight in Table 1.

TABLE 1

| | |
|---|---|
| Example | Comparative Example |

| | Component | 1 | 2 | 3 | 4 | 1 | 2 | 3 |
|---|---|---|---|---|---|---|---|---|
| 1 | 3,4-Epoxycyclohexylmethyl-3′4′- | 30 | 30 | 30 | 30 | 30 | 30 | 30 |
| | epoxycyclohexanecarboxylate | | | | | | | |
| 2 | Bis(3,4-epoxycyclohexyl- | 20 | 20 | 20 | 20 | 20 | 20 | 20 |
| | methyl)adipate | | | | | | | |
| 3 | Bisphenol A diglycidyl ether | 15 | 15 | 15 | 15 | 15 | 15 | 15 |
| 4 | Elastomer particles | 6 | 6 | 6 | 6 | 6 | 6 | 6 |
| 5 | PO-modified trimethylolpropane | 10 | 10 | 10 | 10 | 10 | 10 | 10 |
| 6 | Dipentaerythritol hexacrylate | | 5 | | | 15 | | |
| 7 | 2,5-Dimethylhexane-2,5- | 15 | | | | | | |
| | diacrylate | | | | | | | |
| 8 | PIPE-TBA copolymer | | 15 | | | | | |
| 9 | 2-Benzylpropyl acrylate | | | 15 | | | | |
| 10 | t-Butyl acrylate | | | | 15 | | | |
| 11 | Acrylic acid | | | | | | 15 | |
| 12 | 2-Acryloyloxypropyl naphthalate | | | | | | | 15 |
| 13 | Triallylsulfonium | 2 | 2 | 2 | 2 | 2 | 2 | 2 |
| | hexafluoroantimonate | | | | | | | |
| 14 | 1-Hydroxycyclohexyl | 2 | 2 | 2 | 2 | 2 | 2 | 2 |
| | phenyl ketone | | | | | | | |
| | Total | 100 | 105 | 100 | 100 | 100 | 100 | 100 |
| Evaluation | | | | | | | | |
| 1 | Folding endurance test (Number | 160 | 170 | 150 | 150 | 25 | 70 | 160 |
| | of folding) | | | | | | | |
| 2 | Film impact strength (J/cm) | 60 | 70 | 65 | 60 | 20 | 55 | 60 |
| 3 | Izod impact test (kJ/cm²) | 5.2 | 5.0 | 4.9 | 4.8 | 2.5 | 4.2 | 4.3 |
| 4 | Storage stability (viscosity | Unchanged | Unchanged | Unchanged | Unchanged | Unchanged | Changed | Changed |
| | change after one month) | | | | | | | |

1) 3,4-Epoxycyclohexylmethyl-3′4′-epoxycyclohexanecarboxylate (UVR-6110, manufactured by Union Carbide Corp.)
2) Bis(3,4-epoxycyclohexylmethyl)adipate (UVR-6199, manufactured by Union Carbide Corp.)
3) Bisphenol A diglycidyl ether (Epicoat 828, manufactured by Japan Epoxy Resins Co., Ltd.)
4) Elastomer particles (Reginous Bond RKB, average particle diameter: 100-200 nm, manufactured by Reginous Chemical Industries Co., Ltd.)
5) PO-modified trimethylolpropane (Sunnix GP-400 (molecular weight: about 400), manufactured by Sanyo Chemical Industries, Ltd.)
6) Dipentaerythritol hexacrylate (DPHA, manufactured by Nippon Kayaku Co., Ltd.)
7) 2,5-Dimethylhexane-2,5-diacrylate (manufactured by Osaka Organic Chemical Industry Co., Ltd.)
8) PIPE-TBA copolymer (copolymer of p-iso-propenyl phenol and t-butyl acrylate (Mw: 10,700, t-butyl acrylate content: 50 mol %, manufactured by JSR Corp.)
9) 2-Benzylpropyl acrylate (BzPA, manufactured by Osaka Organic Chemical Industry Co., Ltd.)
10) t-Butyl acrylate (TBA: manufactured by Osaka Organic Chemical Industry Co., Ltd.)
11) Acrylic acid (manufactured by Wako Pure Chemical Co., Ltd.)
12) 2-Acryloyloxypropyl naphthalate (Viscoat 2100, manufactured by Osaka Organic Chemical Industry Co., Ltd.)
13) Triallylsulfonium hexafluoroantimonate (UVI-1697, manufactured by Dow Chemical)
14) 1-Hydroxycyclohexyl phenyl ketone (Irgacure 184, manufactured by Ciba Specialty Chemicals Co., Ltd.)

### Test Example

Izod Impact Test

(1) Preparation of Test Specimen

The photocurable resin composition was selectively irradiated with laser beams at a laser power of 100 mW at the irradiation surface (liquid surface) and a scanning speed at which the cure depth of each composition was 300 □m using a solid creator “SCS-300P” (manufactured by Sony Manufacturing Systems, Inc.) to form a cured resin layer (thickness: 200 μm). This step was repeated to form a test specimen according to JIS.

The test specimen was removed from the solid creator. The resin composition adhering to the surface of the test specimen was removed by washing. After washing, the test specimen was allowed to stand in a thermo-hygrostat at a temperature of 23° C. and a humidity of 50% for 24 hours, followed by a heat treatment at 120° C. for 6 hours.

(2) Measurement

The test specimen thus prepared was allowed to stand in a thermo-hygrostat at a temperature of 23° C. and a humidity of 50% for 24 hours. The Izod impact strength was measured according to JIS 7110. The results are shown in Table 1.

Folding Endurance Test

(1) Preparation of Test Specimen

A liquid resin was applied to a glass plate to form a coating with a thickness of 200 μm. The coating was irradiated with light at 500 mJ/cm² using a high-pressure mercury lamp to obtain a cured film. The cured film was allowed to stand in a thermo-hygrostat at a temperature of 23° C. and a humidity of 50% for 24 hours, followed by a heat treatment at 120° C. for 6 hours.

(2) Measurement

The cured film thus prepared was allowed to stand in a thermo-hygrostat at a temperature of 23° C. and a humidity of 50% for 24 hours. A test specimen with a dimension of 12 cm×3 cm was cut out from the film. The folding endurance test was carried out using an MIT folding tester. The number of folding operations required for the test specimen to fracture was counted. The initial load was 200 g. The results are shown in Table 1.

Measurement of Film Impact Strength

(1) Preparation of Test Specimen

A cured film was prepared under the same conditions as applied to the preparation of the film for the folding endurance test.

(2) Measurement

The cured film was allowed to stand in a thermo-hygrostat at a temperature of 23° C. and a humidity of 50% for 24 hours. A test specimen with a dimension of 10 cm×10 cm was cut out from the film. The impact strength of the film was measured using a film impact tester manufactured by Yasuda Seiki Seisakusho, Ltd. A plastic ball with a diameter of 12 mm was used as the impact ball.

Evaluation of Storage Stability

(1) Evaluation

The viscosity was measured using a B-type viscometer manufactured by Tokyo Keiki Co., Ltd. immediately after preparation and after storage for one month at 23° C. The viscosity was measured at 25° C. using an HM-2 rotor. The storage stability was deemed to be invalid if the viscosity after one month was twice or more the viscosity immediately after preparation. The storage stability was deemed to be valid if the viscosity after one month was less than twice the viscosity immediately after preparation. The results are shown in Table 1.

As is clear from the results of Example 1 shown in Table 1, the cured film containing the component (A) which is a component generating a carboxyl group during a curing reaction exhibited superior folding endurance, film impact strength, Izod impact strength, and significantly improved toughness as compared with the case (Comparative Example 1) where only the component (E) was added as an acrylic monomer. On the other hand, the storage stability of the liquid resin was very poor and could not be accepted in practice in the cases in which an acrylic compound inherently possessing a carboxyl group was used in replace of the component (A) (Comparative Examples 2 and 3), although there was certain improvement in the toughness of the product.

The above results confirm that the photofabricated three dimensional objects formed from the composition of the present invention containing a component generating a carboxyl group have excellent toughness and the liquid resin exhibits good storage stability. The composition of the present invention is thus useful for fabricating parts requiring high impact resistance.

1. A photocurable resin composition comprising:
(A) a component comprising a carboxyl group that may dissociate in the presence of an acid,
(B) a cationically polymerizable compound, and
(C) a cationic photoinitiator.

2. The photocurable resin composition according to claim 1, wherein the component (A) comprises a compound (a1) having a structure of the following formula (1), 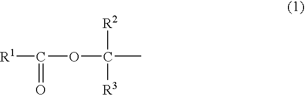
wherein R¹ represents an organic group having a polymerizable carbon-carbon double bond, and R² and R³ individually represent an alkyl group having 1-10 carbon atoms or an aryl group having 6-14 carbon atoms.

3. The photocurable resin composition according to claim 1, wherein the component (A) comprises a compound (a2) having the structure 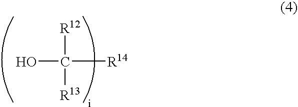
wherein R¹² and R¹³ individually represent an alkyl group having 1-10 carbon atoms or an aryl group having 6-14 carbon atoms, R¹⁴ is an organic group with a valence of i, the R¹⁴ group indicating a single bond when i is 2, and i is an integer of 2-4, provided that one of R¹², R¹³, and R¹⁴ is an alkyl group having 1-10 carbon atoms.

4. The photocurable resin composition according to claim 1, wherein the component (A) comprises a compound (a3) having the structure 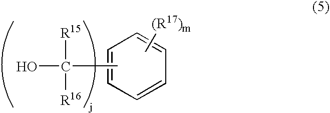
wherein R¹⁵ represents an alkyl group having 1-10 carbon atoms, R¹⁶ represents an alkyl group having 1-10 carbon atoms or an aryl group having 6-14 carbon atoms, R¹⁷ individually represents an alkyl group having 1-5 carbon atoms, j is an integer of 2-4, and m is an integer of 0-4, provided j+m≦6.

5. The photocurable resin composition according to claim 1, wherein the component (A) comprises a compound (a4) having the structure 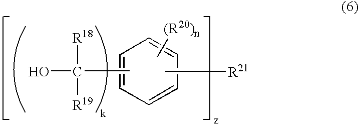
wherein R¹⁸ represents an alkyl group having 1-10 carbon atoms, R¹⁹ represents an alkyl group having 1-10 carbon atoms or an aryl group having 6-14 carbon atoms, R²⁰ individually represents an alkyl group having 1-5 carbon atoms, R²¹ is an organic group having a valence of z, —O—, —S—, —CO—, or SO₂, k is an integer of 1 or 2, n is an integer of 0-3, and z is an integer of 2-4.

6. The photocurable resin composition according to claim 1, wherein the component (A) comprises 2,5-dimethylhexane-2,5-di(meth)acrylate or 1,3-di(2-hydroxypropyl)benzene-di(meth)acrylate.

7. The photocurable resin composition according to claim 1, wherein the component (A) comprises a compound (b1) having the structure 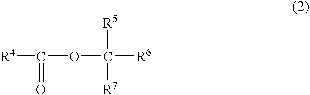
wherein, R⁴ represents an organic group having a polymerizable carbon-carbon double bond, R⁵ represents an alkyl group having 1-10 carbon atoms, and R⁶ and R⁷ represent an alkyl group having 1-10 carbon atoms, monovalent alicyclic group having 6-20 carbon atoms, or monovalent aryl group having 6-20 carbon atoms.

8. The photocurable resin composition according to claim 1, wherein the component (A) comprises a compound (b2) having the structure 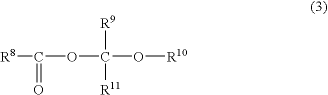
wherein R⁸ represents an organic group having a polymerizable carbon-carbon double bond, R⁹ represents a hydrogen atom, alkyl group having 1-10 carbon atoms, alicyclic group having 3-10 carbon atoms, aryl group having 6-10 carbon atoms, or aralkyl group having 7-11 carbon atoms, R¹⁰ and R¹¹ individually represent an alkyl group having 1-10 carbon atoms, haloalkyl group having 1-10 carbon atoms, alicyclic group having 3-10 carbon atoms, aryl group having 6-10 carbon atoms, or aralkyl group having 7-11 carbon atoms, or any two of R⁹, R¹⁰, and R¹¹ may bond to form a 5-7 member ring.

9. The photocurable resin composition according to claim 1, wherein the component (A) comprises a compound (c), which is a (co)polymer prepared from monomers comprising the compounds (a) and/or (b).

10. The photocurable resin composition according to claim 9, wherein the (co)polymer is prepared from monomers comprising 10-100 mol % of component (b).

11. The photocurable resin composition according to claim 9, wherein the polystyrene-reduced weight average molecular weight of the copolymer (c) determined by gel permeation chromatography (GPC) is 1,000-500,000

12. The photocurable resin composition according to claim 1, wherein the proportion of the component (A) used in the photocurable resin composition of the present invention is 1-50 wt %.

13. The photocurable resin composition according to claim 1, wherein the component (B) contains 50 wt % or more of epoxy compounds.

14. The photocurable resin composition according to claim 1, wherein the component (B) is present in an amount from 20-90 wt %.

15. The liquid photocurable resin composition according to claim 1, further comprising (D) elastomer particle having a number average particle diameter of 10 to 1,000 nm.

16. The liquid photocurable resin composition according to claim 1, further comprising (E) an ethylenically unsaturated monomer other than the component (A), and (F) a radical photoinitiator.

17. The liquid photocurable resin composition according to claim 1, further comprising (G) a polyether polyol compound having one or more hydroxyl groups in the molecule.

18. A photofabricated product obtained by curing the liquid photocurable resin composition according to claim 1 by applying light.
